(19) United States
(12) Patent Application Publication
(10) Pub. No.: US 2003/0140251 A1
(43) Pub. Date: Jul. 24, 2003

(54) Method and system for securing a computer having one or more network interfaces connected to an insecure network

(75) Inventors: Richard Marin, Evanston, IL (US); Joshua Landsman, Skokie, IL (US); Jason Rexilius, Evanston, IL (US)

Correspondence Address: GREER, BURNS & CRAIN, LTD., Suite 2500, 300 South Wacker Drive, Chicago, IL, 60606, US

(73) Assignee: SecureNet Technologies, Ltd.

(21) Appl. No.: 10/131,856

(22) Filed: Apr. 25, 2002

Related U.S. Application Data
(63) Continuation-in-part of application No. 10/055,767, filed on Jan. 23, 2002.

(51) Int. Cl. H04L 9/00

(52) U.S. Cl. 713/201

(57) ABSTRACT

The present invention relates to an improved system and method for securing a computer having at least one network interface connected to an insecure network when the computer is not utilizing the insecure network, which includes the steps of building an array of at least one network interface including a unique identifier for uniquely identifying each at least one network interface and a status associated to each unique identifier for indicating the status of the unique identifier, determining whether the computer is active, turning off the insecure network when it is determined that the computer is inactive, turning on the network when it is determined that the computer is active, and waiting for a predefined time period to repeat from the step of determining whether the computer is active.

### RELATED APPLICATION

This is a Continuation-In-Part application of Ser. No. 10/055,767 filed Jan. 23, 2002 for METHOD AND SYSTEM FOR SECURING A COMPUTER CONNECTED TO AN INSECURE NETWORK, herein incorporated by reference.

The present invention generally relates to a method and system for securing a computer having at least one network interface connected to an insecure network when the computer is not utilizing the insecure network.

It is currently becoming more common for a typical computer to be connected to multiple networks at any given time. For example, a computer may be connected to an intranet via a local area network (LAN) and/or the Internet via a Digital Subscriber Line (DSL), a cable modem connection or a T connection. Because continuous connection to the Internet (i.e., an insecure network) using these various connections is becoming the standard in the computer industry, a typical computer is vulnerable to unwanted connections or intrusions from the insecure network at any given time as long as the computer is turned on and hooked up to the Internet. Thus, a method to secure the computer from such unwarranted connections is needed to protect the computer from any potentially damaging intrusions.

There are currently several commercially available software programs, such as ZoneAlarm Pro® manufactured by ZoneLabs, San Francisco, Calif., McAfee Firewall® manufactured by Network Associates, Inc., Santa Clara, Calif., Norton Internet Security 2002® manufactured by Symantec Corp., Cupertino, Calif., Norton Personal Firewall 2002® manufactured by Symantec Corp., Cupertino, Calif. and BlackIce Defender® manufactured by Defender Network ICE Corporation, San Mateo, Calif., that place a firewall between the computer and the insecure network. In particular, the ZoneAlarm® program allows users to decide which applications can and cannot use the Internet. An Internet Lock is implemented in the ZoneAlarm(g program for blocking Internet traffic while the computer is unattended or while the Internet is not being used. The McAfee Firewall(program, on the other hand, filters all the applications, system services, and protocols, including file and printer shares (NetBIOS), IP protocols (TCP/IP, UDP/IP), service-based protocols (FTP, Telnet), ARP/RARP, and Dynamic Host Configuration Protocol (DHCP). Additionally, the firewall blocks the IPX and the NetBEUI on a per device basis.

The Norton Internet Security® 2002 program and Norton Personal Firewall® 2002 program that blocks incoming hacker attacks while allowing trusted applications to connect to the computer. Lastly, the BlackIce Defender® scans the DSL, cable modem or dial-up Internet connection for hacker activity. When an attempted intrusion is detected, the traffic from that source will be automatically blocked. As a result, any unwanted intrusion is avoided. In all these examples, the connection between the computer and the insecure network remains connected. Basically, all of the prior solutions filter the connection to the insecure network. In other words, while the computer is connected to the insecure network, the known programs provide a security system in front of the gateways or ports to the computer. The programs determine whether a requesting source is trusted or untrusted, and only the trusted sources are allowed access to the gateway or the ports.

The problem with these prior programs is that it is too difficult to list or identify all the trusted sources. As a result, they are generally riddled with multiple security leaks or shortcomings. As shown, there is a need for an improved method for securing the computer from the insecure network.

Accordingly, it is an object of the present invention to provide an improved security program which more completely protects computers from hazards borne by an insecure network.

### BRIEF SUMMARY OF THE INVENTION

The present invention is directed to an improved method and system for securing a computer having at least one network interface connected to an insecure network when the computer is not utilizing the insecure network, which includes the steps of building an array of at least one network interface including a unique identifier for uniquely identifying each of at least one network interface and a status associated to each unique identifier for indicating the status of the unique identifier, determining whether the computer is active, turning off the insecure network when it is determined that the computer is inactive, turning on the network when it is determined that the computer is active, and waiting for a predefined time period to repeat from the step of determining whether the computer is active.

### DESCRIPTION OF THE DRAWINGS

FIG. 1 is a schematic diagram of a network system in which the present method is implemented according to one embodiment of the invention;

FIG. 2 is a flow chart illustrating an overall method of the present invention according to one embodiment of the invention;

FIG. 3 is a flow chart illustrating the subroutine for the step of building an array of network interface indexes shown in FIG. 2 according to one embodiment of the invention;

FIG. 4 is a flow chart illustrating the subroutine for the step of building an array of network interface types shown in FIG. 2 according to one embodiment of the invention;

FIG. 5 is a flow chart illustrating the subroutine for the step of building an array of network interface statuses shown in FIG. 2 according to one embodiment of the invention;

FIG. 6 is a flow chart illustrating the subroutine for the step of obtaining the total network traffic shown in FIG. 2 according to one embodiment of the invention;

FIG. 7 is a flow chart illustrating the subroutine for the step of the network method shown in FIG. 2 according to one embodiment of the invention;

FIG. 8 is a flow chart illustrating the subroutine for reading the command variable shown in FIG. 7 according to one embodiment of the invention;

FIG. 9 is a flow chart illustrating the subroutine for turning on the insecure network shown in FIGS. 2 and 7 according to one embodiment of the invention; and,

FIG. 10 is a flow chart illustrating the subroutine for turning off the insecure network shown in FIG. 7 according to one embodiment of the invention.

### DETAILED DESCRIPTION

Broadly stated, the present invention is directed to a method and system for securing a computer having at least one network interface connected to an insecure network when the computer is not utilizing the insecure network. Rather than simply filtering the requesting source through the connection to the insecure network, as proposed in the prior art, the present invention provides a way to completely disconnect the computer from the insecure network when the computer is not utilizing the insecure network. Thus, there is no need to filter the requesting sources, because once the computer is disconnected from the insecure network, no data is allowed to be received or transmitted through the insecure network. Any communication through the insecure network is completely disabled. As a result, any security leaks to the system would be greatly reduced by the present invention, and the network security is improved.

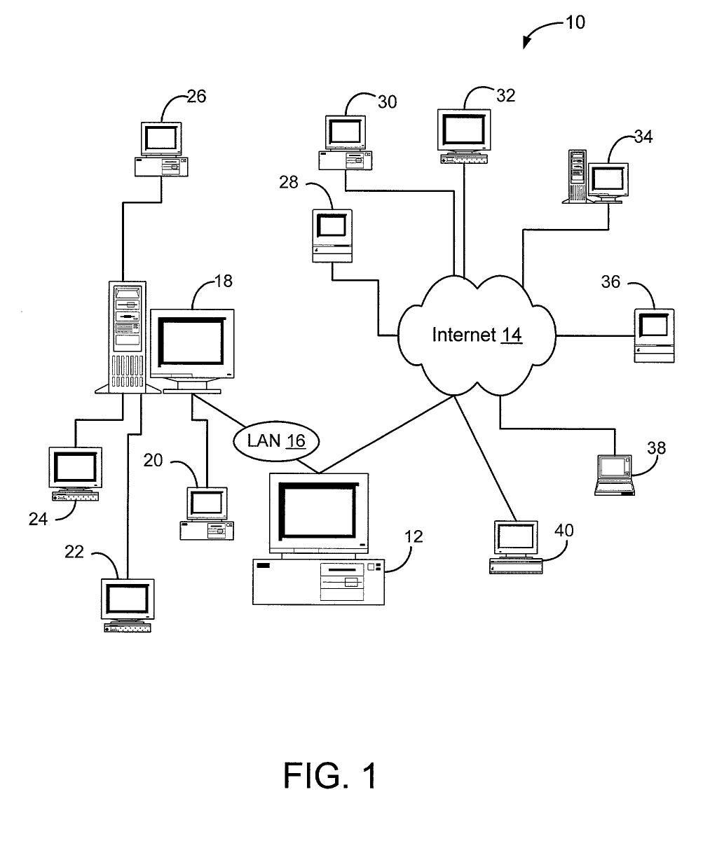

A schematic diagram of a network system is shown in FIG. 1, and indicated generally at 10. A computer 12 is shown to be connected to the Internet 14 (i.e., an insecure network) and a LAN 16 (a secure network) running an intranet via a computer server 18. As shown, there are multiple computers 20, 22, 24, 26 including the computer 12, which are referred to as client computers, connected to the server computer 18. The Internet 14 also shows multiple computers 28, 30, 32, 34, 36, 38, 40 including the computer 12. However, in practice, the Internet generally includes millions of computers connected at any given time, but, for simplicity, only 8 computers are shown. As a result of these various unidentified computers connected to the Internet, the computer 12 is highly vulnerable to unwanted connections, such as from hackers or transmitters of potentially disabling computer viruses.

Although the insecure network shown 10 is preferably connected to the Internet, other types of networks can be used in conjunction with the Internet or even in place of it. For example, the network connection may include other Wide Area Networks (WANs) or even LANs. The present invention can be implemented with any type of network that is considered insecure, and these other implementations should be apparent to one skilled in the art.

However, because the network system 10 is contemplated as varying greatly in type, complexity and size, an explanation of the current preferred embodiment of the network topology is given for clarification purposes. Thus, simply as an example, a computer 12 installed with the Microsoft® Windows® operating system having a continuous connection to the Internet (i.e., insecure network) will be used as an example in describing one implementation of the present invention. However, other implementations with different software programs, such as network security programs, network programs or operating systems, are contemplated, and they are considered to be within the scope of the present invention.

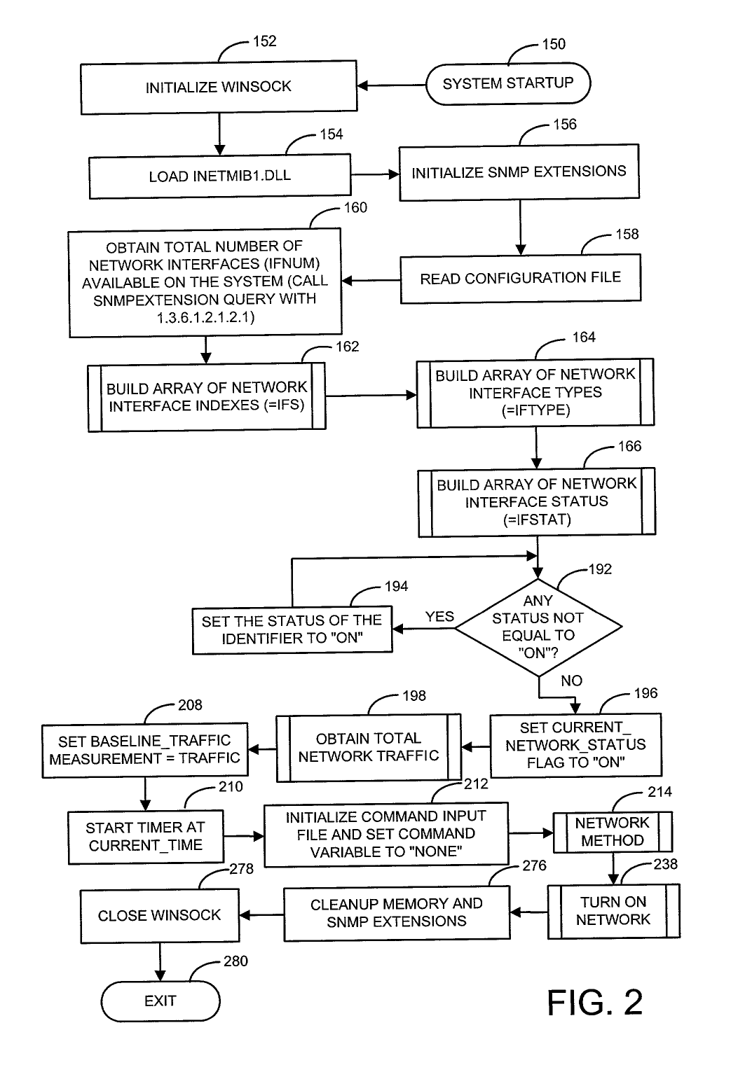

Turning to an important aspect of the illustrated embodiment of the present invention, a flow chart of the preferred functionality of one embodiment of the present invention is shown in FIG. 2. The present invention is preferably implemented as an executable software program within the program controlling the connection to the insecure network. However, other implementations, such as firmware or hardware, are contemplated, and it should be understood that these other implementations are considered to be within the scope of the present invention.

At system startup (e.g., the execution of the software program implemented with the present invention) (block 150), as is typical with most programs, some initialization steps are executed. In the present embodiment, any socket support for managing the insecure connection is first initialized (block 152), and the driver(s) having an object identifier for managing the insecure connection is also loaded at the start of the process (block 154). More specifically, in the case of the Windows® operating system implementation, the winsock will be initialized and the “INETMIB1.DLL” file will be loaded. In addition, commands for the Internet standard protocol(s), such as the Simple Network Management Protocol (“SNMP”) extensions, are also initialized (block 156). The present invention is implemented with a configuration file that stores configuration information, such as a default time threshold, relating to the present invention. Thus, as part of the initialization steps, the configuration file of the present invention is also read at the start (block 158).

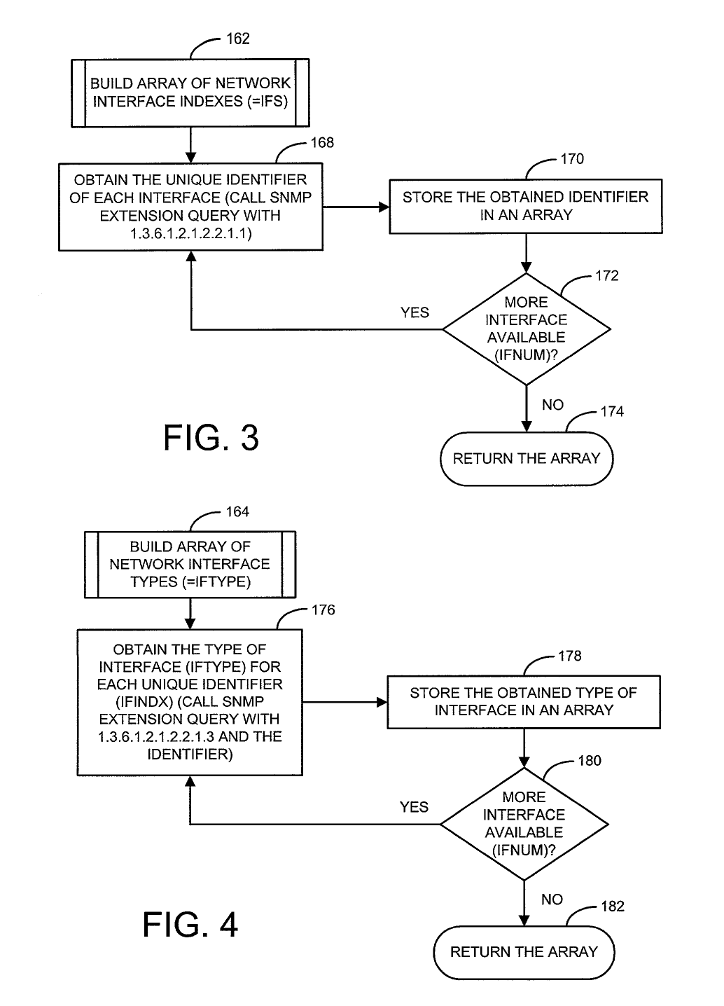

After the initialization steps have been completed, a total number of the network interface(s) that are available on the system (ifnum) is obtained (block 160) by calling the SNMPEXTENSION QUERY with 1.3.6.1.2.1.2.1. As shown, the present invention contemplates on a computer with multiple network interfaces. As a result, an array with the available network interface(s) is preferably built, which includes a unique identifier for uniquely identifying each of the network interface(s) and a status link to each unique identifier for indicating the status of that identifier. In particular, an array of the network interface indexe(s) (=ifs) is first built (block 162), followed by the network interface type (=iftype) (block 164) and the network interface status (=ifstat) (block 166) being appended to the array, which are all shown in FIGS. 3, 4 and 5, respectively.

Turning now to FIGS. 3, 4 and 5, a flowchart illustrating the subroutine for the step of building an array of network interface indexes (block 162), network interface types (block 164) and network interface statuses (block 166) are shown, respectively. In FIG. 3, for building an array of the network interface indexes, a unique identifier (=ifindx) of one of the network interfaces is first obtained (block 168) by calling the SNMPEXTENSION QUERY with 1.3.6.1.2.1.2.2.1.1. The obtained identifier is then stored in the array (block 170). It is next determined whether there are more network interfaces available (block 172). If so (block 172), the process returns to the step of obtaining a unique identifier for a next interface (block 168). If, on the other hand, there are no more network interface(s) available (block 172), the process returns the array with all the obtained unique identifier(s) (block 174).

It should be noted that the previously obtained total number of network interface(s) is used (ifnum) for determining whether there are more network interface(s). However, other implementations can also be used, and these various implementations are appreciated by one skilled in the art and are within the scope of the present invention.

Similarly, for the step of building the array of network interface types (=iftype) 164 shown in FIG. 4, the type of network interface (iftype) is obtained for one of the previously obtained identifier(s) (ifindx) in the array (block 176) by calling the SNMPEXTENSION QUERY with 1.3.6.1.2.1.2.2.1.3 with the identifier. The obtained network interface type is then stored in the array associated specifically to the identifier (block 178). The subroutine again determines whether there are more network interface(s) available (ifnum) (block 180). If so, the subroutine loops to obtain the type of network interface for another identifier in the array (block 176). Otherwise, if there are no more network interface(s) available (block 180), the array is returned with the obtained network interface types (block 182).

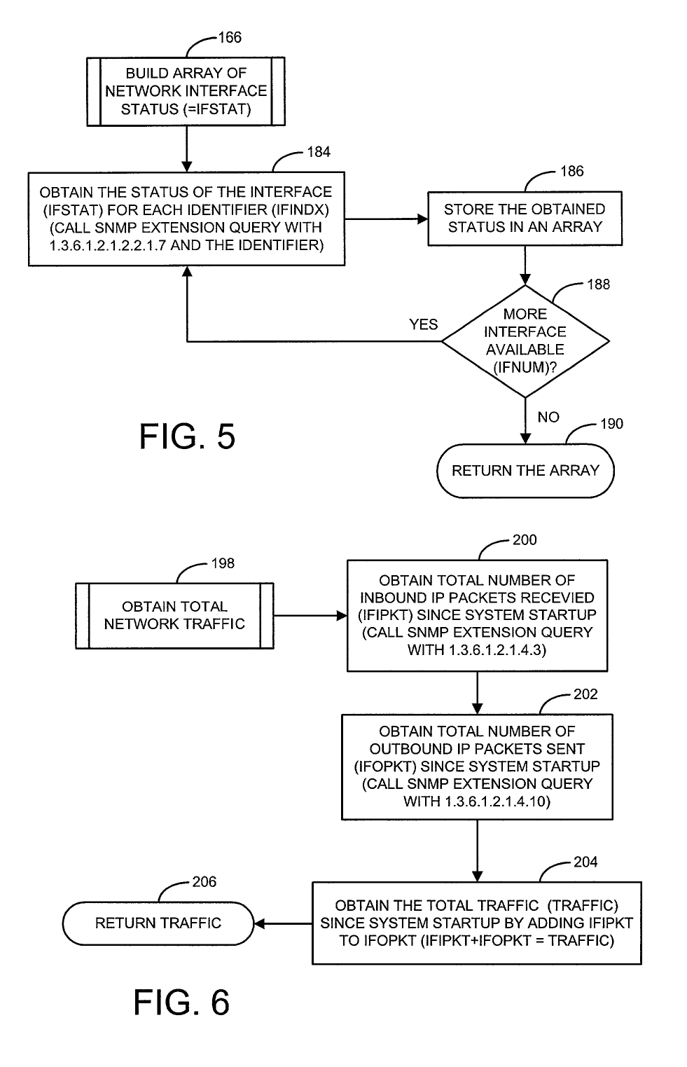

Now that the array has a list of unique identifiers and network interface types, the process continues to the next subroutine of the step of building an array of network interface statuses (block 166) shown in FIG. 5. Again, the first step of the subroutine is to obtain a network interface status (ifstat) of one of the unique identifiers (ifindx) in the array (block 184), which is done by calling the SNMPEXTENSION QUERY with 1.3.6.1.2.1.2.2.1.7 with the identifier. The obtained status is accordingly stored in the array (block 186) associated to the identifier. As in the previous subroutines, a determination of whether there are more network interface(s) (ifnum) is made (block 188). If there are more network interface(s), the subroutine reloops to the step of obtaining the network interface status for a next identifier in the array (block 184). Otherwise, the array is returned with the obtained network interface status (block 190).

Referring back to FIG. 2, once the array has been built, it is next determined whether there is any network interface status in the array that does not equal to “on” (block 192). In other words, it is determined whether there are any network interface statuses that do not indicate on. If so, for any network interface statuses that are not turned on, the status is set to on (block 194) and reloops to check if there is another network interface status that does not equal to on (block 192). Once it has been ensured that all the network interface statuses equal to on, a current_network_status flag is set to “on” to indicate that the insecure network is currently on (block 196).

In this embodiment, the entire network interface(s) is/are preferably turned on, even including the ones that may be off, to ensure that all the network interface(s) is/are uniform across the broad at the beginning of the method. Although uniformity throughout the network interface(s) is preferred to avoid any conflicts when running the processes, the present invention may, nevertheless, be implemented to allow inconsistencies among the network interfaces when the insecure network is either on or off. However, since these implementations tend to be more complicated, uniformity among the network interfaces is preferred. Nonetheless, these other implementations have been noted and contemplated, and they are within the scope of the present invention.

Next, another subroutine for obtaining the total network traffic is processed (block 198), and a detailed description of the subroutine is shown in FIG. 6. The first step is to obtain a total number of inbound Internet Protocol (“IP”) packets received (ifipkt) since the start of the method (i.e., system startup) (block 200). To obtain the total number of inbound IP packets in the SNMP environment, the SNMPEXTENSION QUERY is called with 1.3.6.1.2.1.4.3. The next step is to obtain a total number of outbound IP packets sent (ifopkt) since the system startup (block 202) by calling the SNMPEXTENSION QUERY with 1.3.6.1.2.1.4.10. The total number for the inbound IP packets (ifipkt) and the outbound IP packets (ifopkt) are then added to obtain the total network traffic (traffic) (block 204). The total network traffic (traffic) since system startup is returned to the process shown in FIG. 2.

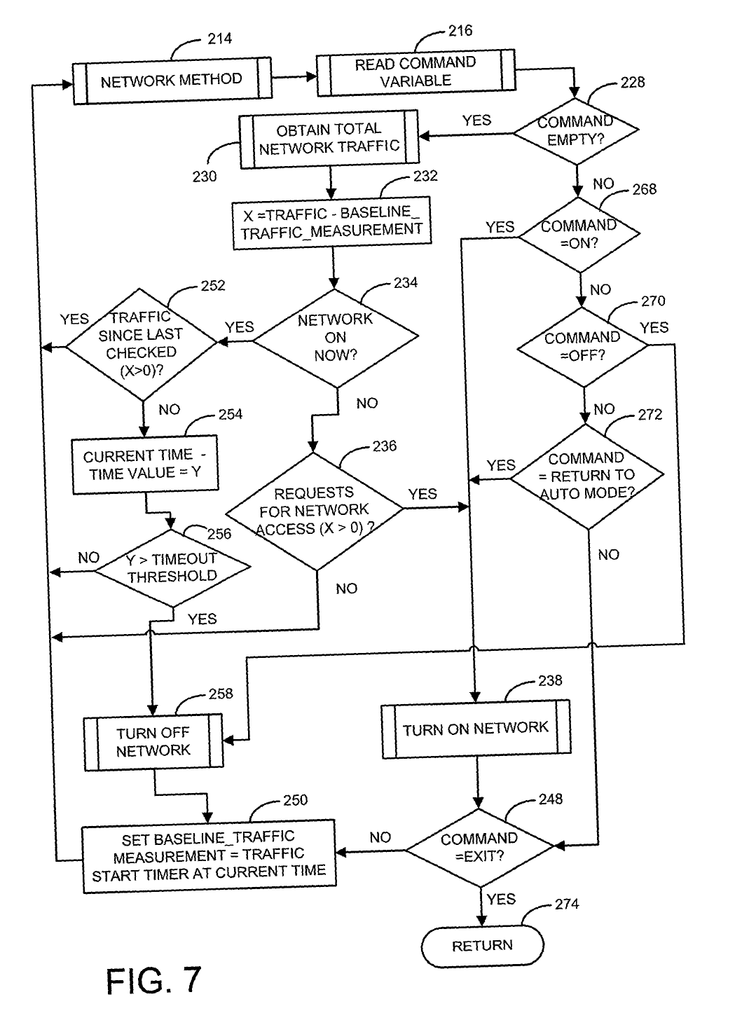

Referring again to FIG. 2, once the total network traffic (traffic) is obtained (block 198), a Baseline_Traffic_Measurement variable is set to the obtained total network traffic (block 208). Also, at this time, the timer is started at the current time (block 210), and a command input file is initialized, followed by a command variable being set to “none” (block 212). A network method for determining whether the insecure network is active is finally executed (block 214), which is shown in FIG. 7. From the network method, the insecure network is turned on or off according to whether the insecure network is active.

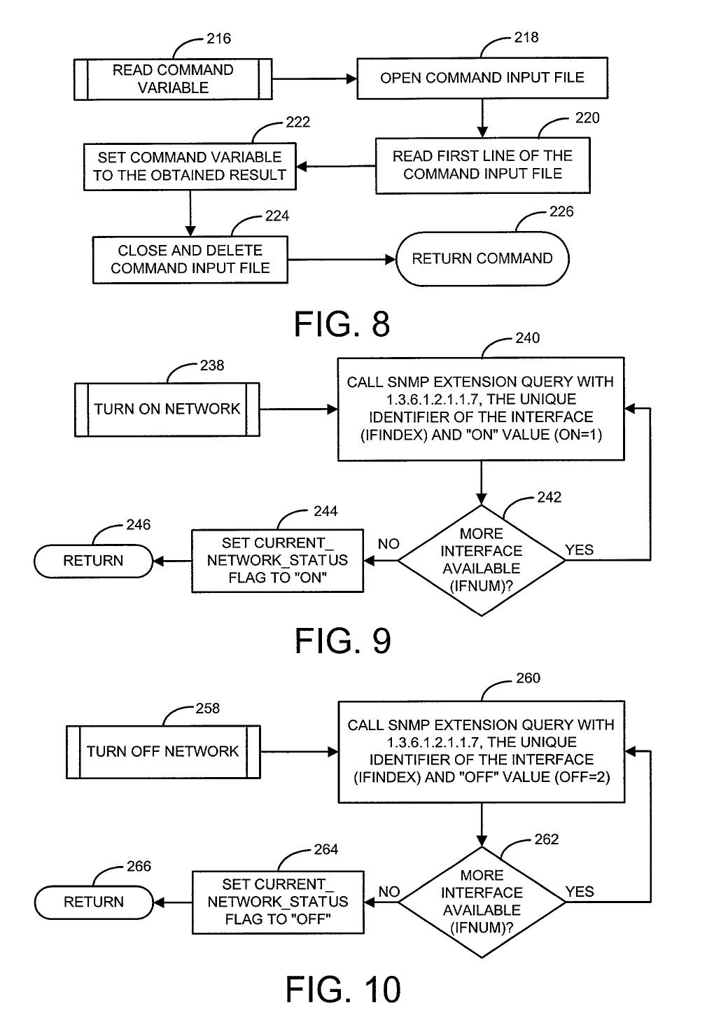

Turning now to FIG. 7, another subroutine for reading the command variable is processed (block 216) and shown in FIG. 8. Turning for a moment to FIG. 8 to the subroutine of reading the command variable, the command input file is first opened (block 218) to read a first line in the file (block 220). The command variable is set to the read result, which is the first line in the file (block 222). Once the command variable is set, the command input file is closed and deleted (block 224), and the subroutine ends at this point by returning the command variable (block 226).

Referring back to FIG. 7, after the command variable is returned from the subroutine of reading the command variable (block 216), the network method continues to the next step of determining whether the command variable is set to empty (block 228). Since it is possible for the first line of the command input file to be empty, the command variable will be set to empty in this case. If the command variable is in fact empty (block 228), the subroutine for obtaining the total network traffic shown in FIG. 6 is again executed (block 230). Once the total network traffic (traffic) is obtained, an X variable is set to a value obtained by subtracting the previously defined Baseline_Traffic_Measurement variable (shown in FIG. 2) from this recently obtained traffic variable defining the total network traffic (block 232). It is next determined whether the network is currently on (block 234). If not, it is then determined whether there are any requests for network access (block 236), specifically the X variable is checked to determined whether it is greater than zero (e.g., X>0). If the X variable is not greater than zero (block 236), the process loops back to start the network method all over again (block 214). However, if the X variable is greater than zero (block 236), this indicates that there are requests for network access. Accordingly, the insecure network will be turned on to process those requests (block 238), and the subroutine of turning on the insecure network shown in FIG. 9 will be initialized.

Turning now to FIG. 9, in order to turn on the insecure network (block 238) (FIG. 8), the network interface status of one of the unique identifiers in the array is set to on (block 240) by calling the SNMPEXTENSION QUERY with 1.3.6.1.2.1.1.7 with the unique identifier (ifindx) and the on value (on=1). It is then determined whether there are more network interfaces available (ifnum) in the array (block 242). If so, the subroutine loops back to the step of setting the network interface status of another identifier to on (block 240). If, on the other hand, there are no more network interface(s) available (block 242), which means that all the network interface(s) has/have been processed, the current_network_status flag is again set to on to indicate that the insecure network is on (block 244), and the subroutine ends and returns (block 246) to the method in FIG. 7.

Referring again back to FIG. 7, after the network is turned on (block 238), it is determined whether the command variable is set to exit (block 248). Since it was previously determined that the command variable is empty (block 228), the command variable cannot be set to exit (block 248). Thus, the process continues and sets the Baseline_Traffic Measurement variable to the recently obtained total network traffic, followed also by the timer being reset at the current time (block 250). At this point, the process reloops to the start of the network method, and begins the network method all over again (block 214).

If the network is not currently on (block 234), it is then determined whether there has been network traffic since the last check (block 252), specifically the X variable is checked to determined whether it is greater than zero (e.g., X>0). If the X variable is greater than zero, meaning that there has been network traffic since the last check (block 252), the process reloops again to the start of the network method (block 214). However, if the X variable is not greater than zero (i.e., there has not been any network traffic since the last check) (block 252), it is checked whether the timeout threshold has been exceeded. In particular, a Y variable is set as a value obtained by subtracting a time value (e.g., the value obtained from the timer) from the current time (block 254), and determining whether the Y variable is greater than a timeout threshold value in the configuration file (block 256). If not, the process loops back to the start of the network method (block 214). However, if the Y variable is greater than the timeout threshold value (block 256), meaning the process has been timed-out, the process initiates the subroutine to turn off the network (block 258) shown in FIG. 10.

Turning now to FIG. 10, the subroutine to turn off the network (block 258) is very similar to the subroutine to turn on the network. In this instance, the network interface status of one of the unique identifiers in the array is set to off (block 260) by calling the SNMPEXTENSION QUERY with 1.3.6.1.2.1.1.7 with the unique identifier (ifindx) and the off value (off=2). It is next determined whether there are more network interface(s) available (ifnum) in the array (block 262) in order to process all the network interface(s). If there are more interface(s) available, the subroutine loops back to the step of setting the network interface status of another identifier to off (block 260). Once all the network interface(s) has/have been processed (i.e., if there are no more interfaces available) (block 262), the current_network_status flag is again set to off to indicate that the insecure network is off (block 264), and the subroutine ends and returns (block 266) to the method in FIG. 7.

Referring to FIG. 7, after the insecure network has been turned off (block 258), the Baseline_Traffic_Measurement variable is set to the recently obtained total network traffic, and the timer is restarted at the current time (block 250). At this point, the process again reloops to the start of the network method, and begins the network method all over again (block 214).

Going back to the step of determining whether the command variable is empty (block 228), if the command variable is not set to empty, which means that a command has been requested in the method, the value of the command variable is determined. More specifically, in the present embodiment, the command variable can be set to on, off or return to auto mode. Using the command variable, users can execute actions in the present invention. In other words, the command variable is a user command for controlling the methods in the present invention. It should be noted that different commands are contemplated, depending on the choice of the developer, but these various implementations are within the scope of the present invention.

According to the possible values of the command variable in this embodiment, it is determined whether the command variable is set to turn on the insecure network (block 268). If so, the insecure will be turned on (block 238), resulting in the execution of the subroutine of turning on the insecure network shown in FIG. 9. Again, after the insecure network is turned on (block 238), it is determined whether the command variable is set to exit (block 248). Since the command variable is set to turn on the insecure network, the command variable cannot be set to exit. Thus, the process continues to set the Baseline Traffic_Measurement to the recently obtained total network traffic, and the timer is also restarted at the current time (block 250), which reloops back to the start of the network method (block 214).

If, however, the command variable is not set to turn on the insecure network (block 268), it is next determined whether the command variable is set to turn off the network (block 270). If the command variable is set to turn off the network (block 270), the process will execute the subroutine to turn off the network (block 258) shown in FIG. 10, followed by the Base_Traffic_Measurement being set to the most recently obtained total network traffic and the timer being restarted at the current time (block 250). The process is again relooped to the start of the network method (block 214).

If the command variable is not set to off (block 270), it is then determined whether the command variable is set to return to auto mode (block 272). If this is the case, the auto mode, in this embodiment, is to turn on the network (block 238). Again, the subroutine previously described and shown in FIG. 9 is executed. As shown, after the network is turned on (block 238) or if the command variable is not set to return to auto mode (block 272), it is then determined whether the command variable is set to exit the method altogether (block 248). Since the insecure network has been turned on (block 238) from both instances of the command variable being either set to on (block 268) or set to return to auto mode (block 272), the command variable cannot be set to exit (block 248). The process continues by setting the Baseline_Traffic_Measurement to the recently obtained total network traffic, followed by starting the timer at the current time (block 250) and relooping to the start of the network method (block 214). If, on the other hand, the command is set to exit the method altogether (block 248), the process exits out of the network method and returns to the method shown in FIG. 2 (block 274).

Referring now back to FIG. 2, the insecure network is turned back on (block 238) as a security measure when exiting the process. The subroutine of turning on the insecure network shown in FIG. 8 is again executed. After the network has been turned on (block 238), the memory and the SNMP Extensions are then cleaned up (block 276). Also, the socket support(s) for managing the network connection will also be closed at this time (block 278), which finally ends the whole process (block 280).

The present invention provides a way to completely deactivate the computer with multiple network interfaces from the insecure network when the computer is not utilizing the insecure network. Instead of filtering the requesting source through the connection to the insecure network, as proposed in the prior art, there is no need to filter the requesting sources in the present invention. In addition, computer resources are not unnecessarily wasted for filtering these data packets, because once the computer is deactivated from the insecure network, no data is allowed to be received or transmitted through the insecure network. Any communication through the insecure network is completely disabled. As a result, any security leaks to the system would be greatly reduced by the present invention, and the network security is improved.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

What is claimed is:

1. A method for securing a computer having at least one network interface connected to an insecure network when the computer that is not utilizing the insecure network, the method comprising the steps of:
building an array of at least one network interface including a unique identifier for uniquely identifying each said at least one network interface and a status associated to each unique identifier for indicating the status of said unique identifier;
determining whether the computer is active;
turning off the insecure network when it is determined that the computer is inactive;
turning on the network when it is determined that the computer is active; and,
waiting for a predefined time period to repeat from said step of determining whether the computer is active.

2. The method according to claim 1 wherein prior to said step of building an array further comprises the steps of:
initializing any socket support managing the insecure network;
loading a driver having an object identifier managing the insecure network;
initializing commands of an Internet standard protocol; and,
reading a configuration file for storing configuration information relating to the method.

3. The method according to claim 1 wherein said step of building an array further comprises the steps of:
obtaining a total number of network interfaces available on the computer;
building an array of network interface indexes with a unique identifier for each said at least one network interface;
building an array of network interface types for each said unique identifier; and,
building an array of network interface statuses for each said unique identifier.

4. The method according to claim 3 wherein said step of building an array of network interface indexes further comprises the steps of:
obtaining a unique identifier for one of said at least one network interface;
storing the obtained unique identifier in the array;
determining whether additional ones of said at least one network interface are available;
if there are more said at least one network interface available, repeating from said step of obtaining a unique identifier for one of said at least one network interface; and,
if there are no more said at least one network interface available, returning the array with the obtained unique identifier.

5. The method according to claim 3 wherein said step of building an array of network interface types further comprises the steps of:
obtaining a network interface type for one of said unique identifier;
storing the obtained network interface type for said unique identifier in the array;
determining whether there are more said at least one network interface available;
if there are more said at least one network interface available, repeating from said step of obtaining a network interface type for one of said unique identifier; and,
if there are no more said at least one network interface available, returning the array with the obtained network interface type.

6. The method according to claim 3 wherein said step of building an array of network interface statuses further comprises the steps of:
obtaining a network interface status for one of said unique identifier;
storing the obtained network interface status for said unique identifier in the array;
determining whether there are more said at least one network interface available;
if there are more said at least one network interface available, repeating from said step of obtaining a network interface status for one of said unique identifier; and,
if there are no more said at least one network interface available, returning the array with the obtained network interface status.

7. The method according to claim 1 wherein said step of building an array further comprises the steps of:
determining whether there is a status of said at least one network interface that does not equal to on;
if there is a network interface status that does not equal to on, setting the network interface status to on and repeat from said step of determining whether there is a status of said at least one network interface that does not equal to on; and,
if there is not a network interface status that does not equal to on, setting a Current_Network_Status flag to on.

8. The method according to claim 1 wherein prior to said step of determining whether the computer is active further comprises the steps of:
obtaining a total number of network traffic;
setting a Baseline_Traffic_Measurement variable to the total number of network traffic;
starting a timer at a current time;
initializing a command input file; and,
setting a command variable to empty.

9. The method according to claim 8 wherein said step of obtaining a total number of network traffic further comprises the steps of:
obtaining a total number of inbound data packets received since the start of the method;
obtaining a total number of outbound data packets sent since the start of the method;
obtaining the total number of network traffic by adding the obtained total number of inbound and outbound data packets; and,
returning the total number of network traffic.

10. The method according to claim 1 wherein said step of determining whether the computer is active further comprises the steps of:
processing a command input file;
determining whether a command variable is empty;
if the command variable is not empty, obtaining a total number of network traffic; and,
if the command variable is empty, determining the value of the command variable.

11. The method according to claim 10 wherein said step of processing a command input file further comprises the steps of:
opening the command input file;
reading a first line of the command input file;
setting the command variable to the read first line;
closing and deleting the command input file; and,
returning the command variable.

12. The method according to claim 10 wherein said step of obtaining a total number of network traffic further comprises the steps of:
obtaining a total number of inbound data packets received since the start of the method;
obtaining a total number of outbound data packets sent since the start of the method;
obtaining the total number of network traffic by adding the obtained total number of inbound and outbound data packets; and,
returning the total number of network traffic.

13. The method according to claim 10 wherein said step of obtaining a total number of network traffic further comprises the steps of:
setting a X variable to a value obtained by subtracting a previously obtained total number of network traffic from the recently obtained total number of network traffic;
determining whether the insecure network is currently on;
if the insecure network is currently on, determining whether there are network traffic after a previously check; and,
if the insecure secure network is currently not on, determining whether there are requests for network access.

14. The method according to claim 13 wherein said step of determining whether there are network traffic after a previously check further comprises the steps of:
determining whether the X variable is greater than zero;
if the X variable is greater than zero, there are network traffic after a previously check; and,
if the X variable is not greater than zero, there are no network traffic after a previously check.

15. The method according to claim 13 wherein said step of determining whether there are network traffic after a previously check further comprises the steps of:
if there are network traffic after a previously check, repeating from said step of determining whether the computer is active; and,
if there are no network traffic after a previously check, setting a Y variable to a value obtained by subtracting a previously set time value from the current time.

16. The method according to claim 15 wherein said step of setting a Y variable further comprises the steps of:
determining whether the Y variable is greater than the timeout threshold;
if the Y variable is greater than the timeout threshold, repeating from said step of turning off the insecure network; and,
if the Y variable is not greater than the timeout threshold, repeating from said step of determining whether the computer is active.

17. The method according to claim 13 wherein said step of determining whether there are requests for network access further comprises the steps of:
determining whether the X variable is greater than zero;
if the X variable is greater than zero, there are requests for network access; and,
if the X variable is not greater than zero, there are no requests for network access.

18. The method according to claim 17 wherein said step of determining whether there are requests for network access further comprises the steps of:
if there are requests for network access, repeating from said step of turning on the network; and,
if there are no requests for network access, repeating from said step of determining whether the computer is active.

19. The method according to claim 10 wherein said step of determining the value of the command variable further comprises the steps of:
determining whether the value of the command variable is set to on;
if the value of the command is set to on, repeating from said step of turning on the insecure network;
if the value of the command variable is not set to on, determining whether the value of the command variable is set to off;
if the value of the command variable is set to off, repeating from said step of turning off the insecure network;
if the value of the command variable is not set to off, determining whether the value of the command variable is set to return to auto mode;
if the value of the command variable is set to return to auto mode, repeating from said step of turning on the insecure network;
if the value of the command variable is not set to return to auto mode, determining whether the value of the command variable is set to exit;
if the value of the command variable is set to exit, terminating the method; and,
if the value of the command variable is not set to exit, repeating from said step of determining whether the computer is active.

20. The method according to claim 19 wherein prior to said step of terminating the method further comprises the steps of:
clearing the memory;
uninitializing commands of an Internet standard protocol; and,
closing any socket support managing the insecure connection.

21. The method according to claim 1 wherein said step of turning off the network further comprises the steps of:
setting the status of one of said at least one network interface in said array to off;
determining whether there are more network interfaces in said array;
if there are more network interfaces available in said array, repeating from said step setting the status of one of said at least one network interface in said array to off; and,
if there are no more network interfaces available in said array, setting a Current_Network_Status flag to off.

22. The method according to claim 1 wherein said step of turning off the network further comprises the steps of:
setting the Baseline_Traffic_Measurement variable to equal to the total number of network traffic;
starting a timer at a current time; and,
repeating from said step of determining whether the computer is active.

23. The method according to claim 1 wherein said step of turning on the network further comprises the steps of:
setting the status of one of said at least one network interface in said array to on;
determining whether there are more network interfaces in said array;
if there are more network interfaces available in said array, repeating from said step setting the status of one of said at least one network interface in said array to on; and,
if there are no more network interfaces available in said array, setting a Current_Network_Status flag to on.

24. The method according to claim 1 wherein said step of said step of turning on the network further comprises the steps of:
determining whether a status of the command is to exit;
if the status of the command is to exit, exiting the method; and,
if the status of the command is not to exit, repeating from said step of determining whether the computer is active.

25. The method according to claim 24 wherein said step of exiting the method further comprises the steps of:
setting the Baseline_Traffic_Measurement variable to equal to the total number of network traffic;
starting a timer at a current time; and,
repeating from said step of determining whether the computer is active.

26. A system for securing a computer having at least one network interface connected to an insecure network when the computer is not utilizing the insecure network, the system comprising:
means for building an array of at least one network interface including a unique identifier for uniquely identifying each said at least one network interface and a status associated to each unique identifier for indicating the status of said unique identifier;
means for determining whether the computer is active;
means for turning off the insecure network when it is determined that the computer is inactive;
means for turning on the network when it is determined that the computer is active; and,
means for waiting for a predefined time period to repeat from said step of determining whether the computer is active.

27. A computer program product comprising a computer readable code stored on a computer readable medium that, when executed, the computer program product causes a computer to:
build an array of at least one network interface including a unique identifier for uniquely identifying each said at least one network interface and a status associated to each unique identifier for indicating the status of said unique identifier;
determine whether the computer is active;
turn off the insecure network when it is determined that the computer is inactive;
turn on the network when it is determined that the computer is active; and,
wait for a predefined time period to repeat from said step of determining whether the computer is active.
